(19) United States
(12) Patent Application Publication
(10) Pub. No.: US 2010/0238545 A1
(43) Pub. Date: Sep. 23, 2010

(54) Method for manufacturing lens array and lens array manufactured by the method

(75) Inventors: Hongen Liao, Bunkyo-ku (JP); Takeyoshi Dohi, Setagaya-ku (JP); Makoto Iwahara, Kanagawa-ku (JP)

Correspondence Address: JAMES C. WRAY, 1493 CHAIN BRIDGE ROAD, SUITE 300, MCLEAN, VA, 22101, US

(73) Assignee: DHS Company, Ltd.

(21) Appl. No.: 12/661,601

(22) Filed: Mar. 19, 2010

(30) Foreign Application Priority Data
Mar. 19, 2009 (JP) 2009-67783

(51) Int. Cl. G02B 27/22; B05D 5/06; C08F 2/46; C23F 1/02

(52) U.S. Cl. 359/463; 427/164; 427/487; 216/11

(57) ABSTRACT

The present invention provides a method of manufacturing a lens array for recording or reproducing three-dimensional images with enhanced precision comprising uniform convex lenses of excellent optical properties without difficulties. A plurality of circular plateaus 3m having uniform diameter and shape are formed two-dimensionally arranged with high precision on a transparent substrate 3 by utilizing a laser plotter or an electron beam exposure system. A predetermined amount of transparent liquid resin 5 is dropped onto the respective circular plateaus one after another. The transparent liquid resin is left as it is until it forms dome shapes on the respective plateaus due to its surface tension. The dome shaped transparent liquid resin 5′ is hardened, so that the lens array having excellent and uniform optical properties two-dimensionally regularly arranged is obtained.

### BACKGROUND OF INVENTION

1. Field of the Invention

The present invention relates to a method for manufacturing a micro convex lens array with high precision without difficulty, which is an essential component to integral photography (IP) or integral videography (IV).

2. Brief Description of the Related Art

When a convex lens array comprising micro lenses arranged in two dimension is employed by arranging images on focal planes of the respective micro lenses in the integral photography (IP) or the integral videography (IV) where images are computerized and generated as dynamic images, three-dimensional images having the following characteristic features are obtained: 1) Three-dimensional images are observed without using special spectacles; 2) Three-dimensional images are observed by a plurality of observers simultaneously and 3) Three-dimensional images are reproduced at predetermined positions, even if observers changed their observing positions up or down, or right or left, and observed images are not deformed.

Although the integral photography was proposed about 100 years ago, and theoretically it is an excellent method for recording and reproducing three-dimensional images, practically the integral photography is not widely used up to now. One of the main reasons is that it has been difficult to manufacture suitable lens arrays to fulfill the above mentioned characteristic features of the three-dimensional images.

Since respective lenses of the lens arrays for the integral photography are used for image formation, they should be optically excellent lenses having uniform focal distances and be arranged with high precision. However, if such lens array is manufactured by machining, for example, a plastic substrate, it is very difficult to form respective lenses, because a machining tool for forming respective lenses interferes with surfaces of neighboring lenses. If such lens array is molded by a hot press, there are no such interferences between the surfaces of the lenses and the mold, because mold cavities for respective lenses are formed beforehand and molten plastic is cast in these cavities simultaneously. However, when a lens array comprising tens thousands to hundreds thousands lenses for high quality three-dimensional images is required, it is quite difficult to prepare a flawless mold in which uniform cavities are formed.

As a simple method for manufacturing a lens array, a method of printing a photo-setting ink through a screen is proposed as disclosed in Japanese laid open patent No. 2005-308973. The printing method comprises the following steps. A screen with a certain thickness, in which an array of circular openings is formed, is placed on a transparent substrate. A transparent photo-setting ink is printed onto the substrate through the circular openings of the screen by moving a squeegee on the screen. Printed substrate is kept for several to tens seconds until the printed ink at respective circular openings form a spherical shape due to surface tension of the printed ink. Light is irradiated on the spherically shaped ink, so that the photo-setting ink is hardened. Finally, the transparent substrate, on which convex lenses are regularly arranged (namely a lens array), is obtained.

The lens array manufactured in the above-mentioned way can be used for forming and reproducing three-dimensional images. However, since the screen is moved by the moving squeegee during the printing step, it is difficult to obtain a lens array with high precision such that respective convex lenses are arranged quite regularly. Further, since the circularly printed ink have a certain thickness, the printed ink gradually spreads radially before the ink is hardened, so that it is difficult to attain convex lenses with a stable and uniform radius. Further, the obtained respective lenses have some irregularity around their circumferences, so that they are not exactly circularly formed. Sometimes diameters of the respective lenses fluctuate, because the ink is not uniformly distributed to the respective circular openings due to slightly fluctuated printing conditions. Consequently, the photo-setting ink printing method is not a suitable method for obtaining a lens array comprising uniform lenses arranged with high precision.

As explained above, it has been quite difficult to manufacture the lens array with high precision for recording and reproducing three-dimensional images. And the lens array with high precision has not been manufactured by a simple method such as the photo-setting ink printing method.

If the respective lenses are not properly arranged and have not uniform properties, three-dimensional images with high quality are not observed, but only highly blurred three-dimensional images are observed or distorted three-dimensional images varying dependent on observing directions are reproduced.

### SUMMARY OF THE INVENTION

The present invention is carried out in view of the above-mentioned problems in order to provide a method for manufacturing a lens array with enhanced precision comprising uniform convex lenses of excellent optical properties as keeping advantages of the photo-setting ink printing method.

A first invention is a method comprising steps of: preparing a transparent substrate on which a plurality of circular plateaus are formed in a regularly arranged two-dimensional pattern; dropping a predetermined amount of transparent liquid resin onto the respective circular plateaus one after another; leaving the dropped resin until it forms dome shapes on the respective plateaus due to its surface tension; and hardening the dome shaped resin.

A second invention is a method characterized by that a photo-setting resin is used as the transparent liquid resin in the first invention, and the dome shaped rein is hardened by irradiating light.

A third invention is a method characterized by that the transparent substrate in the first invention is prepared by etching one side of a glass plate such that portions corresponding to the two-dimensionally arranged circular plateaus in the first invention are not etched.

A fourth invention is a method characterized by that the transparent substrate in the first invention is prepared by the following steps: preparing a transparent glass plate or a transparent resin plate; applying a photo-setting resin on a surface of the transparent plate; exposing portions corresponding to the two-dimensionally arranged circular plateaus in order to harden the photo-setting resin, and removing unhardened portion of the photo-setting resin.

A fifth invention is a method characterized by that the transparent substrate in the first invention is prepared by the following steps: preparing a transparent photo-setting resin plate; placing a patterned dry plate on the transparent photo-setting resin plate, wherein two-dimensionally arranged circular holes are formed in the patterned dry plate; hardening portions of the transparent photo-setting resin by irradiating light through the circular holes on the patterned dry plate, and removing unhardened portion of the photo-setting resin plate.

The above-mentioned first to fifth methods have the same characteristic feature as the screen printing method such that surface tension of the photo-setting resin is utilized to form convex lenses without using molds. However, a lens array comprising lenses having uniform and excellent optical properties arranged regularly with high precision compared with the screen printing method, can be obtained without difficulties by employing a photolithographic technique for arranging convex lenses in the lens array with high precision and a computer controlled dispenser to determine dropping amounts of the photo-setting rein for the respective lenses.

### BRIEF DESCRIPTION OF DRAWINGS

FIG. 1 is a plan view of a glass dry plate, on which a lens array pattern is drawn, for manufacturing a lens array by a first embodiment.

FIG. 2 is a cross-sectional view of the glass dry plate illustrated in FIG. 1.

FIG. 3 is a cross-sectional view illustrating a step for transferring the lens array pattern on the glass dry plate to a substrate for a lens array to which a photo resist is applied.

FIG. 4 is a cross-sectional view of the washed substrate after exposed, developed and fixed the substrate illustrated in FIG. 3.

FIG. 5 is a cross-sectional view of the etched substrate.

FIG. 6 is a cross-sectional view of the substrate for the lens array on which plateaus are formed after the photo resist is removed.

FIG. 7 is a perspective view of the substrate and the plateaus thereon illustrated in FIG. 6.

FIG. 8 is a schematic view illustrating a step of dropping a photo-setting resin on a circular plateau formed on the substrate for the lens array by utilizing a dispenser.

FIG. 9 is a schematic view illustrating a further step of dropping the photo-setting resin on a circular plateau next to the circular plateau illustrated in FIG. 8.

FIG. 10 is a schematic view illustrating a further step of dropping the photo-setting resin on a circular plateau next to the circular plateau illustrated in FIG. 9.

FIG. 11 is a schematic view illustrating a finished state of the photo-setting resin dropping steps, where the respective plateaus are covered with spherically shaped resin.

FIG. 12 is a schematic view illustrating a step of irradiating light on the spherically shaped photo-setting resin on the plateaus illustrated in FIG. 11.

FIG. 13 is a schematic view how to utilize the lens array illustrated in FIG. 12 for three-dimensional images, where portions of the substrate except the plateaus are covered with a mask formed on a shielding substrate.

FIG. 14 is a cross-sectional view illustrating a step for transferring the lens array pattern on the glass dry plate to the substrate for the lens array by a second embodiment corresponding to FIG. 3 in the first embodiment.

FIG. 15 is a cross-sectional view illustrating a step where the photo-setting resin corresponding to plateaus is irradiated in order to harden the photo-setting resin.

FIG. 16 is a cross-sectional view illustrating a state where the plateaus are formed after washing out unhardened photo-setting resin following to the step in FIG. 15.

FIG. 17 is a perspective view of the substrate illustrated in FIG. 16 on which formed plateaus are regularly arranged.

FIG. 18 is a cross-sectional view illustrating a step for transferring the lens array pattern on the glass dry plate to a substrate for the lens array by a third embodiment corresponding to FIG. 3 in the first embodiment.

FIG. 19 is a cross-sectional view illustrating a step where the photo-setting resin corresponding to plateaus is irradiated by diffuse light so as to be hardened.

FIG. 20 is a cross-sectional view illustrating a state where the plateaus are formed after washing out unhardened photo-setting resin following to the step in FIG. 19.

FIG. 21 is a perspective view of the substrate illustrated in FIG. 20 on which formed plateaus are regularly arranged.

### DETAILED DESCRIPTION OF THE PREFERRED EMBODIMENTS

Hereinafter, embodiments by the present invention are explained as referring to drawings.

### Embodiment 1

One aspect of the manufacturing steps of the lens array by the present embodiment is explained as referring to FIG. 10.

A reference numeral 3 is a glass substrate employed as a substrate for the lens array. Two-dimensionally regularly arranged circular plateaus are formed on one of the surfaces of the substrate. A reference numeral 5 is a liquid photo-setting resin to be formed into respective lenses of the lens array. A reference numeral 4 is a dispenser which drops a predetermined amount of the liquid photo-setting resin 5 on the substrate. A reference numeral 5′ is the dropped photo-setting resin onto the above-mentioned circular plateaus. The dropped resin forms a part of sphere due to its surface tension.

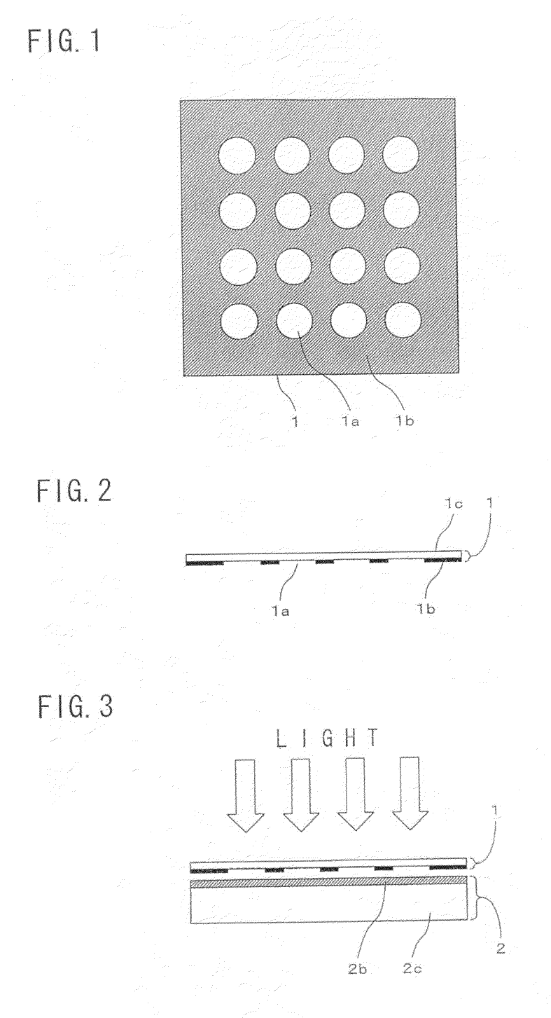

FIG. 10 illustrates one of the steps of embodiment 1 comprising steps illustrated in FIGS. 1 to 13.

A reference numeral 1 in FIG. 1 is a glass dry plate to which a photo resist is applied. The glass dry plate 1 is prepared for forming regularly arranged circular plateaus on the above-explained glass substrate 3. A two-dimensionally arranged plateau pattern is drawn on the photo resist applied to the glass dry plate 1 with high precision by exposing light from a laser plotter or an electron beam exposure system. The exposed glass dry plate 1 is developed, fixed and washed with water. As a result, two-dimensionally regularly arranged circular portions 1a thorough which light passes and a photo resist remaining hatched portion is used as a light shielding portion 1b are formed.

FIG. 2 is the cross-sectional view of the glass dry plate 1 illustrated in FIG. 1. A portion on one side of a glass substrate 1c, where the photo resist is covered with, is the light shielding portion 1b and the remaining portions, where the photo resist is removed so that light can pass through, are the circular portions 1a.

FIG. 3 is the cross-sectional view illustrating the step for transferring the lens array pattern on the glass dry plate 1 to the substrate for the lens array to which the photo resist is applied. The patterned first glass dry plate 1 is stacked firmly onto a second glass dry plate 2 comprising a second glass substrate 2c and a second photo resist 2b applied to an upper surface of the second glass substrate 2c. The second photo resist 2b applied to the second glass substrate 2c is exposed through the patterned first glass dry plate 1.

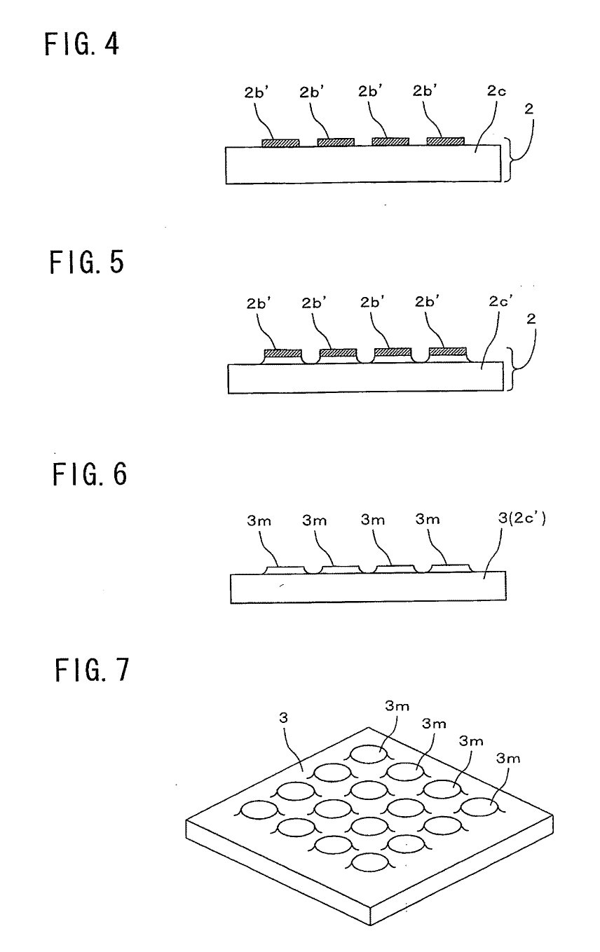

FIG. 4 is the cross-sectional view of the finished second glass dry plate 2 illustrated in FIG. 3 after exposed, developed, fixed and washed with water. The finished glass dry plate 2 comprises two-dimensionally regularly arranged photo resist remaining portions 2b′ and bare glass portion 2c′ where the second photo resist is removed.

FIG. 5 is the cross-sectional view showing the etched state of the finished glass dry plate 2 illustrated in FIG. 4. The photo resist remaining portions 2b′ are not etched, but the bare glass portion 2c′ is etched.

FIG. 6 is the cross-sectional view of the second glass dry plate where the photo resist remained on the portions 2b′ is removed. Since the photo resist remaining portions 2b′ are not etched, they are formed as circular plateaus (or mesas) 3m.

FIG. 7 is the perspective view of the plateaus formed glass substrate 3 illustrated in FIG. 6 on which the flat circular plateaus 3m are arranged regularly.

In FIGS. 1 to 7, procedures for forming the regularly arranged plateaus on the glass substrate are explained, but the glass substrate may be replaced with a transparent plastic substrate.

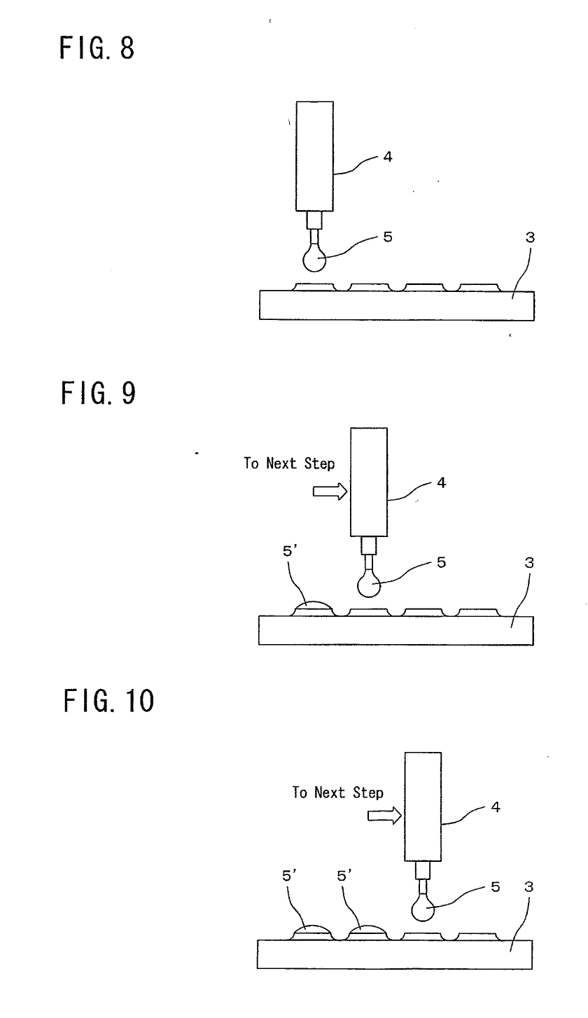

FIG. 8 is the schematic view illustrating the step of dropping a photo-setting resin 5 by utilizing a dispenser 4 onto the circular plateau formed on the glass substrate 3 illustrated in FIGS. 6 and 7. Although not illustrated in FIG. 8, a mechanism which moves the dispenser 4 two-dimensionally relative to the glass substrate 3 or vise versa, and another mechanism which moves the dispenser 4 up and down are arranged in order to drop a desired amount of the photo-setting resin 5 onto the plateaus.

FIG. 9 is the schematic view illustrating a further step of dropping the photo-setting resin on a circular plateau right to the leftmost circular plateau onto which the photo-setting resin 5′ was already dropped. The dropped amount of photo-setting resin 5′ is determined so as to spread all over the plateau and to keep the resin from spilling out of the plateau. For that purposes, the plateau is formed in a circular shape with high precision and a circular peripheral edge of the plateau is formed quite sharply, so that the photo-setting resin is kept on the plateau as forming a partial-spherical shape due to its surface tension. In other words, photo-setting resin 5′ as a whole forms a dome shape.

FIG. 10 is the schematic view illustrating the further step following to the step illustrated in FIG. 9, where the photo-setting resin is going to be dropped onto a circular plateau right to the second circular plateau onto which the resin has been dropped.

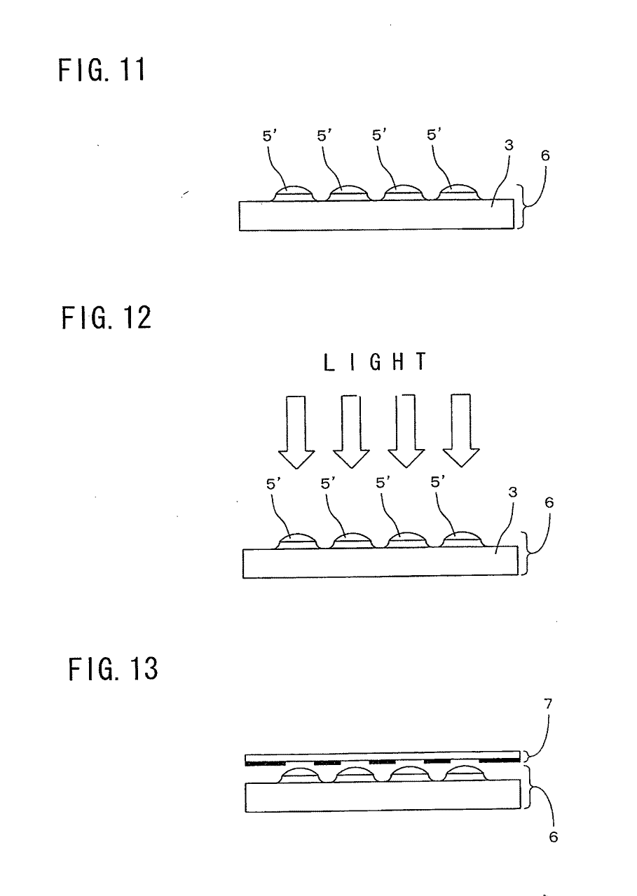

FIG. 11 is the schematic view illustrating the finished state of dropping steps of the photo-setting resin by repeating steps illustrated in FIGS. 8 to 10, so that the resin domes 5′ are formed on the all respective plateaus of the glass substrate 3. As explained above, since the plateau pattern on the first glass dry plate 1 is drawn with high precision by exposing light from the laser plotter or the electron beam exposure system, the formed plateaus are quite regularly arranged. In addition, since dropped amounts of the resin on the respective plateaus are kept uniformly by controlling dropping steps of the resin from the dispenser 4 with high precision by a computer, so that regularly arranged uniform resin domes 5′ are obtained.

FIG. 12 is the schematic view illustrating the step of irradiating light on all the uniformly formed photo-setting resin domes 5′, so that the domes 5′ are hardened as they are.

In the above-explained method, the light is irradiated on the resin dome after the whole resin domes are formed. However, a different method as follows is also possible. The method comprises steps of: dropping the resin onto one circular plateau; irradiating light on the plateau immediately the resin dome 5′ is formed thereon and repeating the dropping step and irradiating step on the whole plateaus one after another.

After the resin domes 5′ are hardened by the irradiated light as keeping their shape as they are, the resin domes 5′ are stuck to the glass substrate 3 firmly, so that the dome shape is stabilized. As a result, a lens array 6, where flat convex lenses formed by the hardened resin domes 5′ are two-dimensionally arranged with high precision, is obtained. If the glass substrate 3 is replaced with the transparent plastic substrate, another lens array 6, where the plastic substrate 3 and the resin dome are monolithically formed, is obtained.

FIG. 13 is the schematic view illustrating an example how to utilize the lens array 6 obtained as explained above for three-dimensional images. Since the portion except lenses formed by the resin domes does not function as a lens so that the portion is not essential to the three-dimensional images, the portion is covered with a light shielding substrate 7 where transparent circular holes having a little bit smaller diameter than the lenses of the lens array 6 are arranged in the same pattern as the lens array 6. Since light is shielded by the substrate 7 so that the light passes only through the lenses of the lens array 6, quite clear images can be recorded and reproduces through the lens array 6.

It is possible that the portion except lenses of the lens array 6 is coated with a light shielding material in place of the light shielding substrate 7.

### Embodiment 2

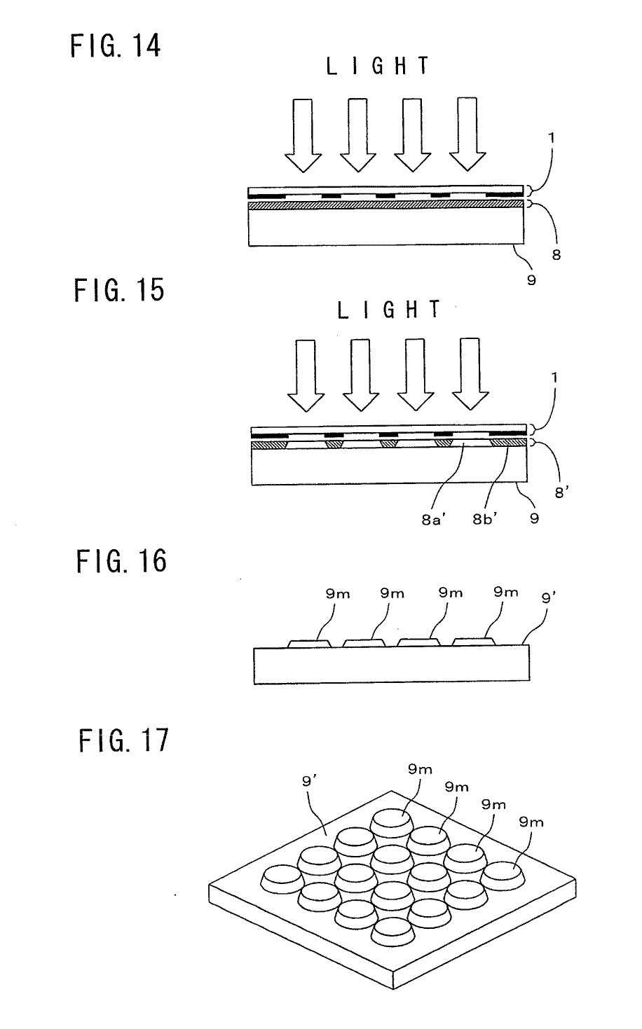

In embodiment 1 illustrated in FIGS. 1 to 13, the circular plateaus, on which the photo-setting resin domes are formed, are formed by etching the glass substrate. In the present embodiment illustrated in FIGS. 14 to 17, however, such circular plateaus are formed without employing the etching process.

FIG. 14 is the cross-sectional view illustrating the step where a highly viscous photo-setting resin 8 is applied to one side of the glass substrate 9 with a predetermined thickness. The drawing shows that light is irradiated to a layer of the photo-setting resin 8 thorough the glass dry plate 1 similar to the one illustrated in FIGS. 1 and 2, comprising regularly arranged light passing circular portions and a remaining light shielding portion, which is stuck firmly to the layer of the photo-setting resin 8.

FIG. 15 shows a state where light irradiated portions of the photo-setting resin layer 8 are assigned a reference character 8a′ (white portion) and remaining non-irradiated portion is assigned a reference character 8b′ (hatched portion).

FIG. 16 shows a state where the plateaus are formed after washing unhardened photo-setting resin 8b′ out of the photo-setting resin layer 8′ following to the light irradiation step illustrated in FIG. 15. As a result, substrate 9′, on which flat circular plateaus 9m are formed, is obtained.

FIG. 17 is the perspective view of the substrate 9′ illustrated in FIG. 16, where the flat circular plateaus 9m are regularly arranged. Since a plateau arranging pattern illustrates in FIG. 17 is quite similar to one that illustrated in FIG. 7, the same steps illustrated in FIGS. 8 to 13 can be applied to the present embodiment in order to obtain a lens array for three-dimensional images.

In the present embodiment, the glass substrate 9 is employed, but the glass substrate 9 may be replaced with a transparent plastic substrate.

### Embodiment 3

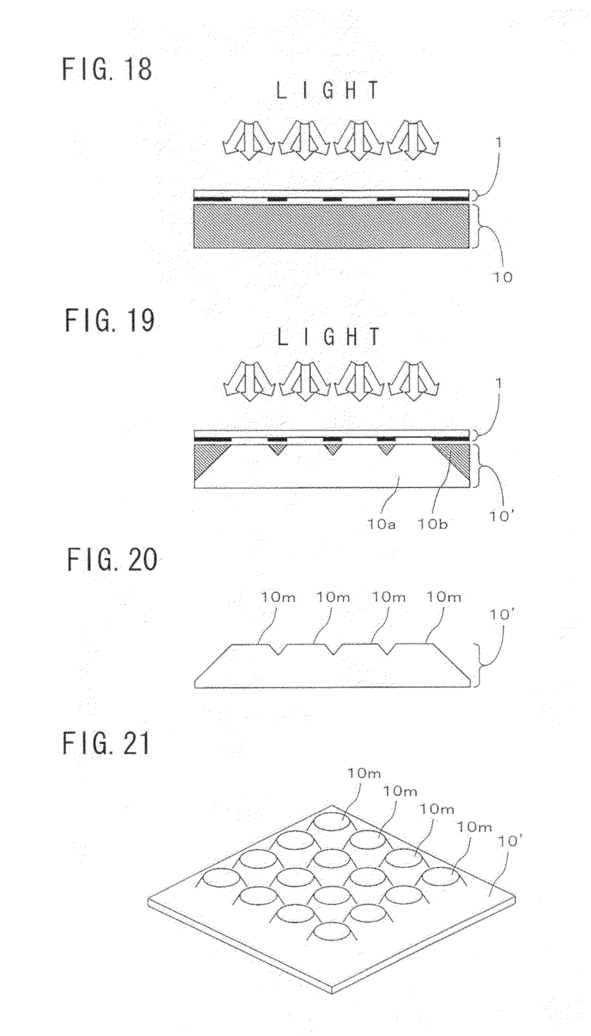

In the present embodiment illustrated in FIGS. 18 to 21, the glass substrate 9 employed in the previous embodiment 2 illustrated in FIGS. 14 to 17 is not required.

FIG. 18 shows a state where slightly diffusive light is irradiated to a thick layer of the photo-setting resin 10 thorough the glass dry plate 1 similar to the one illustrated in FIGS. 1 and 2, comprising regularly arranged light passing circular portions and a remaining light shielding portion, which is stuck firmly to a thick layer of the photo-setting resin 10.

FIG. 19 shows a state where the light irradiated portions 10a′ (white portion) are hardened and remaining portion 10b′ (hatched portion) is unhardened. Since the diffused light is employed in the present embodiment, a shallow upper surface area of the photo-setting resin layer 10 is hardened as patterned by the glass dry plate 1. On the other hand, since the diffused light is employed, even directly under the shielded portion of deeper part of the photo-setting resin layer 10 are irradiated by the diffused light. As a result, the deeper part is hardened so that the hardened part has the same function corresponding to the glass substrate 3 in embodiment 1 or the glass substrate 9 in embodiment 2.

FIG. 20 shows a state where the plateaus 10m are formed after washing unhardened photo-setting resin 10b out of the photo-setting resin layer 10 following to the light irradiation step illustrated in FIG. 19. As a result, substrate 10′, on which flat circular plateaus 10m are formed, is obtained

FIG. 21 is the perspective view of the substrate 10′ illustrated in FIG. 20, where the flat circular plateaus 10m are regularly arranged. Since a plateau arranging pattern illustrates in FIG. 21 is quite similar to one that illustrated in FIG. 7 or FIG. 17, the same steps illustrated in FIGS. 8 to 13 can be applied to the present embodiment in order to obtain a lens array for three-dimensional images.

In embodiments 1 to 3, the respective convex lenses are formed by utilizing surface tension of the photo-setting resin, but hardener-setting resins, thermo-setting resins, self-hardening resins or the like can be used as materials for the lens array, as far as those resins are transparent and can form spherical shapes due to their surface tension effects.

The present invention has the same characteristic feature as the screen printing method such that surface tension of the photo-setting resin is utilized to form convex lenses without using molds. However, since the present invention employs the photolithographic technique for arranging convex lenses in the lens array with high precision and the computer controlled dispenser to determine dropping amounts of the photo-setting rein for the respective lenses, a lens array comprising lenses having uniform and excellent optical properties arranged regularly with high precision compared with the screen printing method, is obtained without difficulties.

Therefore, devices for displaying quite clear three-dimensional static or dynamic images can be manufactured without difficulties at a lower cost, so that various applications such as medical image displays, machine designing, visualizations of fluid flow. And other applications such as entertainments, exhibitions outdoor advertisement and the like are also expected.

1. A method of manufacturing a lens array for three-dimensional image comprising steps of:
preparing a transparent substrate on which a plurality of circular plateaus are formed in a regularly arranged two-dimensional pattern;
dropping a predetermined amount of transparent liquid resin onto said respective circular plateaus one after another;
leaving said dropped resin until it forms dome shapes on the respective plateaus due to its surface tension; and
hardening said dome shaped resin.

2. The method according to claim 1, wherein:
a photo-setting resin is used as said transparent liquid resin, and
said dome shaped rein is hardened by irradiating light.

3. The method according to claim 1, wherein:
said transparent substrate is prepared by etching one side of a glass plate such that portions corresponding to said two-dimensionally arranged circular plateaus are not etched.

4. The method according to claim 1, wherein:
said transparent substrate is prepared by steps of:
preparing a transparent glass plate or a transparent resin plate;
applying a photo-setting resin on a surface of said transparent plate;
exposing portions corresponding to said two-dimensionally arranged circular plateaus in order to harden said photo-setting resin, and
removing unhardened portion of said photo-setting resin.

5. The method according to claim 1, wherein:
said transparent substrate is prepared by steps of:
preparing a transparent photo-setting resin plate;
placing a patterned dry plate on said transparent photo-setting resin plate, wherein two-dimensionally arranged circular holes are formed in said patterned dry plate;
hardening portions of said transparent photo-setting resin by irradiating light through said circular holes on said patterned dry plate, and
removing unhardened portion of said photo-setting resin plate.

6. A lens array for recording or reproducing three-dimensional images manufactured by one of the methods according to claim 1.
